(19) United States
(12) Patent Application Publication
(10) Pub. No.: US 2007/0263820 A1
(43) Pub. Date: Nov. 15, 2007

(54) PRINTING WORKFLOW SERVICES

(75) Inventors: Joseph S. Czyszczewski, Longmont, CO (US); Mark G. Finlan, Atlanta, GA (US); James T. Smith II, Boulder, CO (US)

Correspondence Address: LAW OFFICE OF DAN SHIFRIN, PC - IBM, 14081 WEST 59TH AVENUE, ARVADA, CO, 80004, US

(73) Assignee: International Business Machines Corporation, Armonk, NY (US)

(21) Appl. No.: 11/380,834

(22) Filed: Apr. 28, 2006

(51) Int. Cl. H04M 3/42

(52) U.S. Cl. 379/201.12

(57) ABSTRACT

A computer workfiow services manager includes a data input coupled to receive unprocessed data from a customer, a data output coupled to transmit processed data to the customer, a control input coupled to receive instructions from a workfiow scheduler associated with a grid services broker and a grid service adapters responsive to the control input. A first grid service adapter is operable to provide a link to a first registered grid service, transmit unprocessed customer data to the first registered grid service and receive first processed data from the first registered grid service. The second grid service adapter is responsive to the control input and operable to provide a link to a second registered grid service, transmit the first processed data to the second registered grid service, receive second processed data from the second registered grid service and transmit the second processed data to the data output.

### RELATED APPLICATION DATA

The present application is related to commonly-assigned and co-pending U.S. application Ser. No. 11/______ [IBM Docket # BLD9200500161US1, entitled PRINTER OUTPUT COVERAGE ESTIMATION SYSTEM, filed on the filing date hereof, which application is incorporated herein by reference in its entirety.

### TECHNICAL FIELD

The present invention relates generally to providing computing services, such as printing services and, in particular, to providing web- and grid-based service tools.

### BACKGROUND ART

Due to growing pressure among competitors in regards to pricing in recent years, the production print industry (also known as the output industry) has been struggling to trim print cost. These costs include: printers and peripheral devices, including maintenance and click charges, print servers and processors specific to the pre-processing of print files, paper, toner and other supplies; floor space, special air conditioning and monitoring equipment, power, operations staff, management overhead, disposal of waste paper, and disaster contingency. Additionally, with digital production printing expanding, even a well-planned purchase may not meet the user's needs for as long as it used to. At the same time, the speed, resolutions and color capabilities of new printers continually increase, so that what is bought today will probably depreciate faster than it did in the past. More and more customers are trying to offload functions to reduce costs and increase flexibility. Expertise and volume become key factors in keeping expenses low to maintain and grow revenue and profit margins. Thus, enterprises are rapidly outsourcing output to companies which can realize economies of scale and economies of scope. Even further, offloading or outsourcing these scalable individual processes allows upgrades and resource utilization to be transparent to service bureaus and print providers as technology evolves.

One of the primary problems encountered in the output industry is the cyclical nature of business. Take, for example financial service providers. The majority of their printing expenses align directly with billing cycles. Subsequently, they or the print providers they employ must squeeze most of their print needs into a small monthly window. In order to accommodate high volumes in short periods, print shop architectures must be sized for the maximum load even though the daily average usage is well below this threshold. Peak sizing, of course, leads to increased costs and wasted expenses during idle print times.

The ability to outsource the upstream and downstream processing in document workflows enables businesses to relieve their budgets of software administration and ownership. For a service bureau, the physical act of printing might be considered the singular core competency while preprocessing may be an unwanted cost of doing business.

Consequently, those in the industry are seeking tools which address the foregoing issues and which does not require the acquisition of substantial in-house computing resources in excess of typical day-to-day requirements.

### SUMMARY OF THE INVENTION

The present invention provides numerous benefits, including increasing throughput for all print processes including high-speed color print, reducing total cost of print for customers by reducing fixed assets, eliminating administrative and maintenance costs, offering more optimal and variable price points for pre-processing, and elimination of technology obsolescence for customers. Instead of paying a large fee for products that may be less used or sit idle for certain periods of time and of which only a fraction of the functionality is useful for any one client, the present invention allows customers to pay for exactly what they need and only when it is actually used.

Grid services increase the precision with which focus can be applied to value-added business practices and alleviate customers of unwanted business costs. As a result, customers can realize the benefits of applications without having to incur the overhead. This overhead includes initial software and hardware costs, training, depreciation during low utilization, maintenance and upgrades, missing the benefits of incremental functionality improvements, and owning the information technology staff that must administer the system. Incremental improvements and enhancements to services can be exploited in realtime instead of waiting for upgrades, patches, or new product purchases. Similarly, the menu of services and workflow offerings can be augmented transparently to the end user.

In a web service configuration, the consumer knows specifically who is providing the service. The provider is discovered through Universal Description, Discovery, and Integration (UDDI): an established business relationship, or via browsed websites. In each of these three discovery mechanisms, the client deals directly with an explicit provider.

The components of the present inventions may also exist as grid services where the ultimate provider of service is unknown to the client. From the client perspective, the component is simply a more complex web service. However, the endpoint that is contacted by the caller is not guaranteed to be the provider of service. This mode of operation is analogous to the UDDI case of a web service; but in the grid service case, instance providers that process an incoming request for service are not statically recorded in a registry.

### BRIEF DESCRIPTION OF THE DRAWINGS

FIG. 1 is a block diagram of a workflow framework service of the present invention;

FIG. 2 illustrates a grid-based service according to the present invention;

FIG. 3 is a flowchart of an example of a pre-flight process using the grid framework of the present invention; and

FIG. 4 is a block diagram of a grid-based system in which the present invention may be implemented.

### DETAILED DESCRIPTION OF THE PREFERRED EMBODIMENT

Integration refers to the seamless interoperability among customers, employees, and partners via flexible business processes and a flexible software (i.e. web services) infrastructure. Often integration is a mere afterthought in today's IT environments. However, production environment integration is critical and needs to be simple, dynamic, adaptive, and secure, acting as an enabler for rapid change and augmentation. Virtualization relates to allowing physical resources to be pooled and utilized efficiently and effectively (i.e. shared) regardless of what the resource is or where it is located. By severing the direct physical relationship between services and hardware, dynamic resources are created enabling enterprises to have control to change resources flexibly based on changing business requirements. Virtualization is significant because it improves resource utilization among dynamically changing workloads, enables the effective allocation of resources based on service-level needs and reduces the costs necessary for administrators to manage resources. And, customers can migrate to newer or different software without the worry of catastrophic failure because rolling back to the previously used grid service will not only be transparent, but possibly automatic.

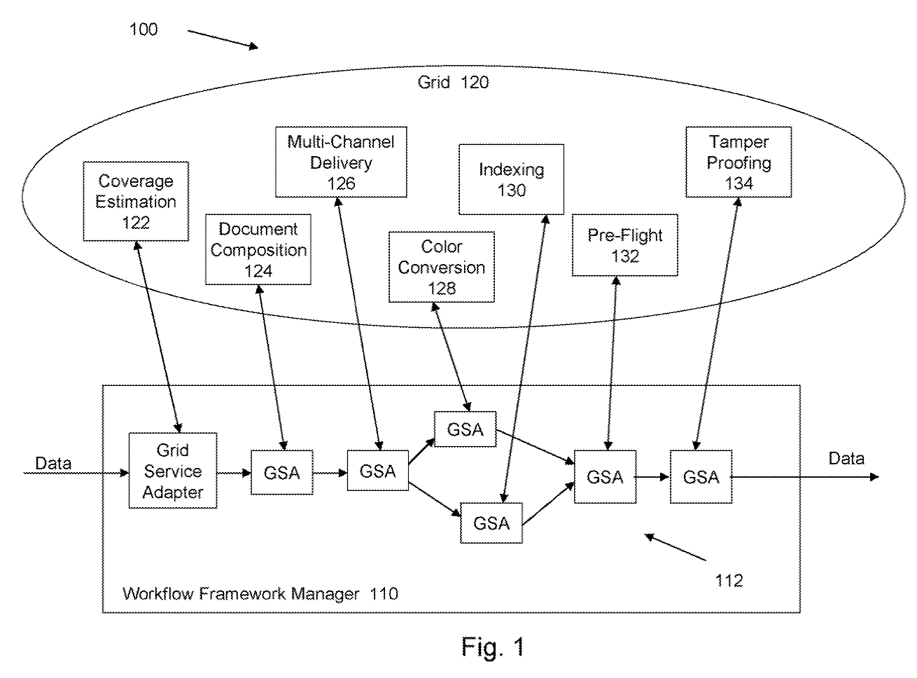

As illustrated in FIG. 1, the framework 100 of the present invention may offer numerous print-related components or services. Data for a print job is sent by a client (user) to a workflow framework manager 110. Depending on the type of service or services desired, unprocessed customer job data is received by one or more registered grid service adapters (GSAs) 112 which send portions of the job to grid service nodes or resources 122-136 in a grid 120. As illustrated, some portions of the job are processed sequentially by the grid service nodes while others may be processed in parallel. The partially processed data are returned from the grid service nodes to the workflow manager 110. The final processed output is then transmitted back to the client.

Some of the services provided by the present invention include, but are not limited to:

Output Coverage Estimation Service 122: Output coverage estimation is a common component required in a variety of document production processes and is typically used to measure the amount of ink or toner required to produce each page in an output job. Output job bids currently are often based on an average shop cost without regard for the actual coverage. Ink and toner are key drivers of the variable cost of an output job. Estimates that assess true coverage more accurately are crucial because there is a significant difference in ink or toner usage for text compared to images and black and white compared to color output. Using standard costing rather than more granular content-based costing can result in missing profit objectives for higher than average coverage jobs or uncompetitive bids for lower than average coverage jobs. Additionally, coverage estimation is used in supply chain optimization for output supplies like toner and in cost centers to charge for actual usage after the job is completed. Output suppliers, vendors and brokers may provide the coverage estimation service, and output customers, brokers, and suppliers may use the service. Output customers may utilize the coverage estimation service to optimize the design and layout of jobs relative to cost. This may enable them to benchmark expenses prior to sending jobs to the print engine and compare costs and alter designs to ensure that budgetary constraints are maintained. Conversely, suppliers may use the service to develop bids that are more precise in an effort to remain competitive in the outsourcing market. Concurrently, more precision in toner usage records, afforded by a coverage estimator, will enable automation and optimization in already established supply chain relationships and cut costs further. For example, the service may calculate the toner used per job and store that information in a database, such that new toner is automatically ordered when a pre-selected re-order point is reached. A variety of estimation algorithms may be supported enabling customers to choose how much accuracy they need to match the requirements of each job. Algorithms that are more exact require more processing capacity and cost more. For example, higher cost color jobs may justify more correctness. Faster analysis capability may be achieved through parallel page and object processing.

Document Composition Service 124: Composition describes the ability to condition data streams on the fly after they have already left their originating application. This enables providers to make every document more personal, and subsequently, more compelling. These tools have great value in areas such as one-to-one personalized marketing. Document layout changes are usually reactive, not anticipated, and composition software allows print streams from various business applications to be altered and enhanced without interrupting document processing. The need for composition services is also increasing due to support for multichannel output, which requires differing layouts for each form of delivery (for example, mail, print, etc.). Providing composition as a variable service enables streamlined and rapid document presentment and distribution alterations that will differentiate output suppliers.

Multichannel Document Delivery Service 126: Crucial to the ability to provide output management applications and solutions is the facility to take processed data and deliver that data to one or more different destinations. The straightforwardness of physical document delivery has been complicated by the shift towards electronic delivery. The need for multichannel delivery is also driven by the shift to higher value personalized content with differing layouts for each channel of output. By providing this capability as a grid service, the actual delivery portion of any process can be abstracted from the overall architecture and easily applied across applications, even in highly complex systems. Some of the various endpoints for delivery include printers, databases, and web servers. Possible delivery options include support for e-mail, facsimile, text messaging and ftp, among others. Beyond the flexibility provided by the componentization, enterprises can eliminate the hardware and software, maintenance and administration associated with FTP, e-mail and other protocols that are not part of the company's primary operations and skills. The multichannel delivery grid service enables an independent personalization grid service to be established for routing documents to the desired output channel. This approach also supports routing based on metadata embedded in the content. Another advantage of the open approach provided by this technique is that new channels can be supported by simply adding new metadata identifiers to the content or personalization service to identify the new delivery service dynamically.

Color Conversion Service 128, A major hurdle in document workflows is the ability to display colors properly within electronic formats and on printed pages across a wide variety of destinations and devices. Based on situations that call for flexibility in color tone and quality, the need exists for a color conversion service that provides the flexibility to handle different needs for different situations. The CMYK (cyan-magenta-yellow-black) color space is common for use in color printers, due to the subtractive properties of inks. Unfortunately, documents for print are usually generated with a different input color space. In these systems, it is necessary to translate colors from any input color space to the output color space. For example, a scanner RGB (red-green-blue) color space might need conversion to a print CMYK color space, or from sRGB to gray.

Document Indexing Service 130: Document indexing encompasses a system to process coded documents and images of documents intelligently to enable searching and business process workflows. Intelligent indexing goes beyond text search to include layout analysis for metadata extraction. Another feature for scanned document images is recognition and conversion of pictures to device independent grayscale. One of the new rules issued by the SEC to enforce the Sarbanes-Oxley Act requires auditing firms to keep every document which influences reports about clients for at least seven years. According to emerging legal interpretations of the rules, every public company as a practical matter must also follow this rule to avoid liability. However, merely saving seven years worth of documents in a database is insufficient. Document retention systems should index material by topic such as contracts or accounting and not just archive based on document type or date. Otherwise, the system becomes difficult to use and maintain. Therefore, it is important to be able to index not only electronic documents, but also scanned images of hard documents to ensure compliance. The shift from analog copiers and printers to multifunction devices (MFDs) is another trend driving the need for a document indexing service. While this trend is also being fueled by consolidation, the greater value is deployment of easy-to-use; networked scanners to capture large volumes of paper documents anywhere and anytime. Capturing documents immediately eliminates paper earlier in its lifecycle to reduce cost and improve reliability, and capturing documents locally improves the ability to describe more metadata information accurately. While these devices are improving in their embedded application capability enabling greater metadata capture, extracting metadata from scanned documents is a difficult image processing issue which requires a great deal of processing.

Document Pre-Flighting Service 132: Document preflight enables enterprises to understand the integrity of a document in terms of anything from proper layout to inclusion of alt necessary resources like font libraries. Without this level of assurance, effort and production time are wasted detecting errors during processing. Additionally, with the usage of a bitmap emulator, viewer customers are able to preview print documents without actually utilizing a print engine. Preferably, the actual pre-flight capability resides with an expert who can insure that production specifications will precisely match preflighting specifications from job to job. The complexity and configuration of the pre-flighting process makes it an ideal candidate for a framework service model. Further, the processing and iteration requirements make it an ideal candidate for a grid services model. Moreover, customers may utilize a pre-flight test service to ensure that a provider can actually handle their job properly before signing a contract or engaging the job. Output customers may utilize the pre-flighting service to optimize the design and layout of jobs relative to cost. Generated reports may contain print job statistics including coverage, costs, job integrity, number of pages, and print run length. Customers may then compare jobs costs and adjust these parameters to ensure an optimal product that does not exceed target costs.

Document Tamper Proofing Service 134: As noted, one of the new rules issued by the SEC to enforce the Sarbanes-Oxley Act requires auditing firms to keep documents which influence reports about clients for at least seven years. However, beyond just the archiving issues that accompany Sarbanes-Oxley lies the problem of tamper proofing the saved documents to provide integrity and adherence to Sarbanes-Oxley. Additionally, there are applications in which documents, such as those including sensitive financial information or contracts, need to be protected to insure that they have not been tampered with. Another need arises from the near universal use of the internet. Writers, photographers, musicians and artists are among those who have taken advantage of the worldwide publishing opportunities provided by the internet. They are all considered “authors” under U.S. copyright law and elsewhere but are frequently taken advantage of by on-line pirates. Watermarking provides authors with a valuable new weapon in the battle to enforce the law in the on-line world. Digital watermarking, sometimes called “fingerprinting,” allows copyright owners to incorporate into their work identifying information which is invisible to the human eye. When combined with new tracking services offered by some of the same companies that provide watermarking technology, copyright owners are able to find illegal copies of their photos and music on the Internet and take appropriate legal action. Digital watermarking may also help ensure that only lawful image and audio files are used, thereby protecting webmasters against inadvertent copyright infringement. A need exists to transform electronic documents easily such that they are tamper proof with a variety of techniques such as watermarking based on the security requirements of the application. The centralized service provided by the present invention which includes a uniform methodology to render documents tamper proof will provide greater ease of use for enterprises and auditing agencies than disparate, non-uniform systems. This service can then take advantage of incremental and real-time improvements to the tamper proofing technology without interfering with daily usage. By being offered tamper proofing as a service, companies with sensitive documents are able to pay only for the time they use it instead of having to purchase and maintain an internal application. In addition, companies do not have to divert time, personnel and other resources away from their central business to become proficient in document tamper proofing. They may simply use a service on-demand and documents may then be protected seamlessly with respect to internal processes. This enables companies to achieve compliance and business process transformation with acts, including Sarbanes-Oxley, HIPAA, Check 21 and others, with as little added overhead and cost to current business and daily processes as possible. Moreover, when tamper proofing is time sensitive, documents may be sent out and tamper proofed with a date and signature at the time of delivery. The same document might then be re-worked and sent out repeatedly until an agreement is reached. In such a case, a service providing the secure functionality takes the certification of the time stamp out of the hands of the author for faster turnover and increased authenticity

The use of brokerage services may optimize service capacity and utilization of the components of the present invention across customers and industries. The service-based workflow framework of the present invention utilizes grid services and intrinsically defines a mechanism for linking customer-deployed services to a broker 140. This system of provider transparency creates a new online marketplace and a virtual industry for the purchase and exchange of software services offered in a collaborative and transient grid. Thus, the broker 140 serves as an intermediary, a central distributor and scheduler of grid services. Customers may deploy common standards-based grid services and register as a provider of service with a broker owned service. The broker 140 provides the same grid service interface to its customers looking to utilize a service. The broker then is able to schedule incoming work to any of the registered services while tracking how much service was supplied by each provider on the grid, such as with a tracking module 150 in the workflow framework manager 110. The service provider may receive compensation for the usage of its grid node and the broker 140 may receive a brokerage fee for each transaction it facilitates, A workfiow framework manager 110 interconnects a collection of services, called directly or through a broker, into a workflow application. A collection of sub-tasks, each dependant on the output of a prior task, are interconnected to provide an full application. Different providers of service may provide all or part of each sub-task. The workflow framework manager 110 manages all applications that are implemented on top of the collection of services. An advantage to vendors functioning as brokers is the ability to pool demand, resulting in improved utilization for suppliers and improved availability for consumers. Additionally, brokers may pool excess peak capacity from large suppliers to support variable loads with complementary windows (such as financial billings versus insurance billings and policies).

The present invention may be implemented through web services, grid services or a combination of the two. Web services are collections of procedures callable over the internet using standard protocols like HTTP and described to clients by a standard XML format known as Web Service Description Language (WSDL). Typically, a web service implementation may be deployed inside an existing web server, such as WebSphere®, using a web service toolkit. Moreover, a Java™-based web service may be deployed inside a servlet container which itself runs inside the web server. From a business perspective, utilizing a web service rather than traditional software offers several benefits. First it provides a simplified mechanism for connecting applications regardless of technology or location. Second, web services are widely distributed and utilized and, subsequently, are based on industry standard protocols with universal support. Third, web services provide support for multiple connections and information sharing scenarios.

Grid services are enhanced web-services which simplify the deployment of complex distributed systems while simultaneously allow for decentralized maintenance and control. A computing grid is formed when disparate computers and systems in an organization—or among organizations—essentially become one large, integrated computing system: a virtual supercomputer. That system may then be applied to problems and processes too large and intensive for any single computer to easily handle alone in an efficient manner as illustrated in FIG. 1. Building a grid is beneficial because the location of the computational resources is abstracted and transparent to the end-user. By establishing this abstraction and interconnection, the available computing power is nearly unlimited. In the case of print workflow, as provided by the present invention, the scalability causes that the speed of the print engine to become the deciding factor of possible impressions per minute (i.e. bottleneck), not the software or hardware. PCs and Windows servers may be only about five percent utilized. Unix Servers may be only about fifteen percent utilized, and mainframes may only be about sixty-five percent utilized. A grid solution brings together these untapped resources to boost computer capacity, meaning less hardware is needed and ROI on current hardware increases.

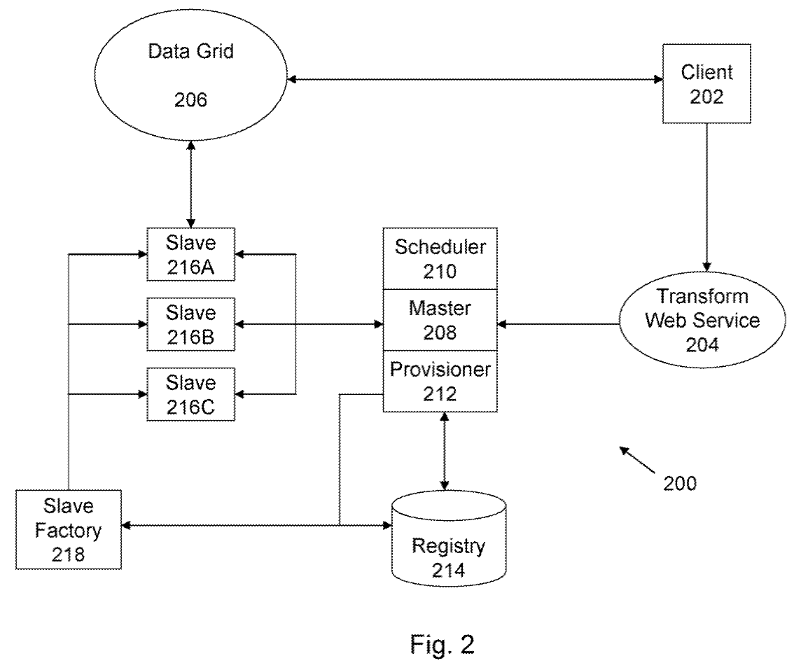

FIG. 2 is a functional diagram of a grid sevice 200 of the present invention whose components are described as follows:

Transform 204: A Transform 204 is the web service with which a Client or customer 202 application interacts and communicates. This point of entry serves as the front end to the entire system 200. A Client 202 contacts a Transform web service 204 to submit a job for transformation, informs the service 204 where the data is located, and then reads back transformed data after processing has completed. The web service 204 itself can be hosted in any servlet container.

Data Grid 206: The Data Grid 206 decouples the storage of data from the processing of the data. For this reason, the Client 202 retrieves or pulls processed data from the Data Grid 206. In addition, the Client 202 may send or push data to the grid 206 before and during processing. This configuration enables a Client's data to be read directly from its own storage device without needing to pass data to a broker or service provider.

Master 208: As part of the workflow framework manager 110, a Master 208 grid service is analogous to the conductor of an orchestra, coordinating and organizing the workloads of all the other services. Technologically, the Master 208 serves as an interface from the Client 202 into the services that perform that actual manipulations by accepting jobs from the Transform front end and notifying Slaves 216 (see below) when work completed is available on the backend, Master-Slave communication is done through standard grid service mechanisms but the data transfer is done through the Data Grid 206. Such a design prevents the Master 208 from becoming a processing or data flow bottleneck.

Scheduler 210: The Scheduler 210 may also be part of the workflow framework manager 110 and determines the timing at which Slaves 216 will process what data. The Scheduler 210 is responsible for maintaining quality of service given the available resources. The Scheduler 210 generally uses secondary storage—a database or even the data grid 206 itself—to maintain knowledge of jobs, Slaves 216 and other information requisite to sustain requisite throughput.

Provisioner 212: The Provisioner 212 may also be part of the workflow framework manager 110 and adds and removes Slaves 216 from nodes on the grid as demand dictates. Its responsibilities include maximizing the efficiency of the grid 200. As a result it has the ability to generate new Slave 216 service processes on machines enlisted with the Registry 214 (see below). In addition, Provisioner 212 may reach outside the grid 200 using a vehicle such as Lightweight Directory Access Protocol (LDAP) to temporarily utilize a grid-unaware machine by deploying grid software to it and invoking a Slave 216 service for processing. The Provisioner 212 assists in the balance between costs associated with increasing speed and performance by adding new machines to the grid, thereby enhancing profitability.

Registry 214: The Registry 214 is responsible for storing relevant data about the structure of the grid, including known Slave Factories 218 and Slaves 216, as welt as information that enables the grid 200 to expand and contract seamlessly. The Registry 214 is preferably backed by a distributed database, ensuring that it is not a potential single point of failure. The Registry 214 may be integrated into the broker 140 or may be external. In fact, the Registry 214 may itself be a grid service.

Stave 216: Slaves 216A, 216B, 216C (or collectively referred to as Slaves 216) are responsible for processing jobs assigned by the Master 208. All Slaves 216 need not constantly perform the same tasks but each may perform many different functions. For example, one Slave 216A might perform POF to PostScript Transforms, another Stave 216B might perform document composition, and still a third Slave 216C might perform coverage estimation. A Slave 216 pushes and pulls data directly from the Data Grid 206. Since the Slaves 216 may be grid services themselves, multiple levels of recursion and nesting are possible, further enhancing the robustness of the design and enabling the grid 200 to scale easily.

Slave Factory 218: A Slave Factory 218 is a grid service that enlists itself with the Registry 214 when the grid software activates and whose sole purpose is to create Slaves 216 processes. Typically, a Slave Factory 218 will sit idle on a machine within the grid 200 waiting for requests for service. When the demand for a Slave 216 arises and the request is received, the Slave Factory 218 deploys the software necessary for the Stave 216 and notifies the Registry 214 that the Slave 216 exists and is ready to fulfill alt or part of a job request.

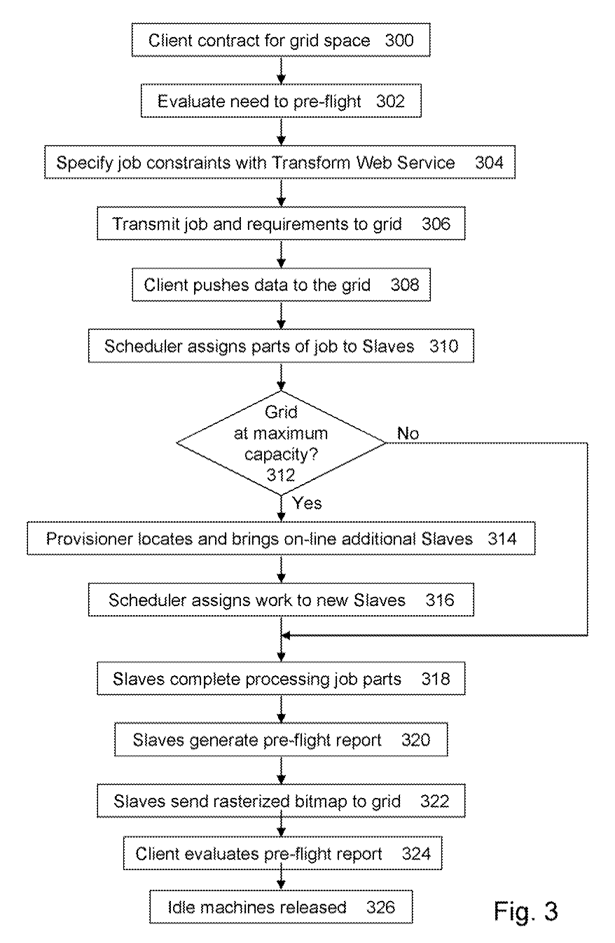

The flow chart of FIG. 3 illustrates one example of a preflight process using the grid framework 200 of the present invention.

Step 300) To accommodate large quantities of data and inexpensive prices, the Client or customer 202 contracts to obtain space in the Data Grid 206.

Step 302 The Client 202 determines the need to preflight a job before sending it to its print provider to save on possible additional downstream costs.

Step 304 The Client 202 contacts a Transform Web Service 204 to specify the constraints of the job, for example, that the job needs to be pre-flighted within the next twenty-four hours.

Step 306) The Transform Web Service 204 in turn communicates to the grid Master 208 the job and requirements. For simplicity, we will assume the grid Master 208 is able to accept the job with the provided parameters.

Step 308) The Client 202 begins pushing data to the Data Grid 206.

Step 310) The Scheduler 210 assigns parts of the job to different Slaves 216.

Step 312) The grid 200 may reach its maximum capacity.

Step 312) The Provisioner 212 takes note of this fact and determines the need for expansion.

Step 314) The Provisioner 212 locates additional available grid node machines that are capable of performing the requested work and deploys the relevant software to them as new Slaves 216.

Step 316) The Scheduler 210 in turn assigns work to the additional Slaves 216.

Step 318) The Slaves 216 complete their processing step.

Step 320) The Slaves 216 generate a pre-flight report.

Step 322) The Slaves 216 push a rasterized bitmap back to the Data Grid 206.

Step 324) The Client can view the job in a bitmap emulator as part of an evaluation of the pre-flight report.

Step 326) After job completion, the Provisioner 212 determines if any machines are now idle and releases them from their duties as Slaves 216.

A significant advantage to the grid framework service is the ability for the service to exist inside of a multi-step workflow. The process is able to recursively call another service before processing completes and therefore can generate arbitrarily long chains of services. Moreover, because of the distributed nature of the grid there is no distinction between a workflow step happening at a customer site, on customer-owned computers, a step happening off-site, or even occurring at a different customer's site on its computers on behalf of another client. This seamless nature is what facilitates the same flexibility in deployment based on customer needs as is achieved in the software itself.

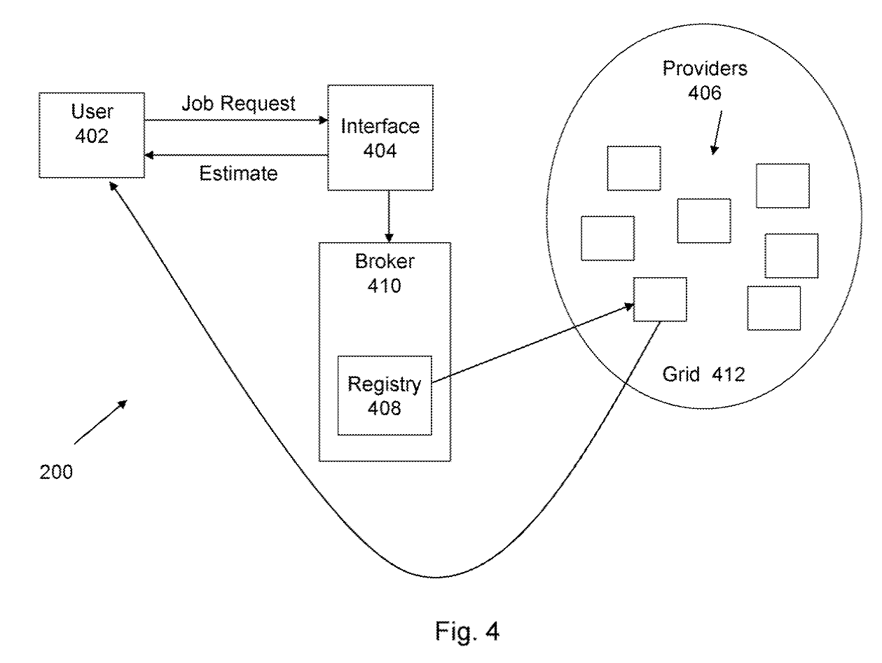

FIG. 4 illustrates a grid-based system 400. Providers 406 in a grid 412 register unused computing capacity with the registry 408. Users 402 submit job requests through an appropriate interface 404 to the broker 410. For a fee, the broker 410 then matches job requests with providers 406. In the grid-based service of FIG. 4, the ultimate provider(s) 406 may be unknown to the user 402 which is only purchasing computing power. A provider may itself also be a user and may purchase capacity from the broker during times of high utilization. The user only pays the provider for the capacity it needs, and only when it is needed. The computing provider is able to sell excess its capacity during times of low utilization, thereby reducing wasted resources.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and CD-ROMs and transmission-type media such as digital and analog communication links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for providing computing services and print output workflow services or a method for deploying computing infrastructure comprising integrating computer readable code into a computing system for providing such services.

What is claimed is:

1. A method for providing computer services, comprising:
receiving a plurality of deployments of common standards-based grid services from a plurality of computer grid service providers;
registering each deployment as a computer service provider;
making the registered deployments available to customers;
receiving a request for a grid service from a customer;
matching the requested grid service with a deployment; and
linking the customer with the provider of the matched registered deployment, whereby the requested grid service is provided to the customer.

2. The method of claim 1, wherein;
the request for a grid service comprises a request for a series of grid services to be performed in a predefined sequence;
matching comprises matching the requested grid services with a plurality of registered deployment; and
linking the customer comprises linking the customer with the providers of the plurality of matched registered deployments, whereby the requested grid services are provided to the customer in the predefined sequence.

3. The method of claim 1, wherein the grid services comprises output workflow services.

4. The method of claim 3, wherein the output workflow services are print services selected from a group comprising coverage estimation, document composition, multi-channel delivery, color conversion, indexing, pre-flighting, tamper-proofing and image delivery.

5. The method of claim 1, further comprising charging the customer a fee to be paid to the provider of the provided grid service based on the amount of grid services provided to the customer.

6. The method of claim 1, further comprising charging the customer a fee for being linked with the provider of the provided grid service.

7. A method for providing print output workflow services, comprising:
receiving a plurality of deployments of common standards-based grid services from a plurality of output workflow service providers;
registering each deployment as a service provider;
making the registered deployments available to customers;
receiving a customer request for an output workflow service;
matching the requested service with a registered service; and
linking the customer with the provider of the matched registered services whereby the matched registered service is provided to the customer.

8. The method of claim 7, wherein,
the request for an output workfiow service comprises a request for a series of output workflow services to be performed in a predefined sequence;
matching comprises matching the requested services with a plurality of registered services; and
linking the customer comprises linking the customer with the providers of the plurality of matched registered services, whereby the matched registered services are provided to the customer in the predefined sequence.

9. The method of claim 7, wherein the output workfiow services are print services selected from a group comprising coverage estimation, document composition, multi-channel delivery, color conversion, indexing, pre-flighting, tamper-proofing and image delivery.

10. The method of claim 7, further comprising charging the customer a fee to be paid to the provider of the provided output workflow service based on the amount of services provided to the customer.

11. The method of claim 7, further comprising charging the customer a fee for being linked with the provider of the matched service.

12. A computer workfiow services manager, comprising:
a data input coupled to receive unprocessed data from a customer;
a data output coupled to transmit processed data to the customer;
a control input coupled to receive instructions from a workflow scheduler associated with a grid services broker;
a first grid service adapter coupled to the data input and responsive to the control input, the first grid service adapter operable to:
provide a link to a first registered grid service;
transmit unprocessed customer data to the first registered grid service; and
receive first processed data from the first registered grid service; and
a second grid service adapter coupled to receive the first processed data from the first grid service adapter, responsive to the control input and operable to:
provide a link to a second registered grid service;
transmit the first processed data to the second registered grid service;
receive second processed data from the second registered grid service; and
transmit the second processed data to the data output.

13. The workflow services manager of claim 12, further comprising:
third and fourth grid service adapters interposed between the first and second grid service adapters, each coupled to receive the first processed data from the first grid service adapter, responsive to the control input wherein:
the third grid service adapter is operable to:
provide a link to a third registered grid service;
transmit the first processed data to the third registered grid service;
receive third processed data from the third registered grid service; and
transmit the third processed data to the second grid services adapter; and
the fourth grid service adapter is operable to:
provide a link to a fourth registered grid service;
transmit the first processed data to the fourth registered grid service;
receive fourth processed data from the fourth registered grid service; and
transmit the fourth processed data to the second grid services adapter.

14. The workfiow services manager of claim 12, wherein the registered grid services are print services.

15. The workflow services manager of claim 14, wherein the print services selected from a group comprising coverage estimation, document composition, multichannel delivery, color conversion, indexing, pre-flighting, tamper-proofing and image delivery.

16. The workflow services manager of claim 12, further comprising:
means for tracking grid services used by a customer; and
means for determining a charge to the customer for the amount of each grid service used.

17. A workflow services framework, comprising:
a workflow services broker;
a registry sponsored by the broker with which grid service providers register;
means sponsored by the broker for receiving customer requests for grid services;
a grid services manager operable to match a customer request with a registered service provider and link customer data with the matched registered service providers, whereby the matched registered service is provided to the customer.

18. The workflow services framework of claim 17, wherein the grid services manager comprises:
a scheduler operable to determine when registered grid services process customer data; and
a master grid service operable to receive unprocessed customer data from the receiving means and partially processed data from registered grid services and, responsive to the scheduler, transmits unprocessed and partially processed data to registered grid services.

19. The workflow services framework of claim 17, wherein the registered grid services are print services.

20. The workflow services framework of claim 19, wherein the print services selected from a group comprising coverage estimation, document composition, multi-channel delivery, color conversion, indexing, pre-flighting, tamper-proofing and image delivery.

21. The workflow services framework of claim 17, further comprising
means for tracking grid services used by a customer; and
means for determining a charge to the customer for the amount of each grid service used.

22. The workflow services framework of claim 17, further comprising means for charging the customer a fee for being linked with the provider of the matched service.

23. A computer program product of a computer readable medium usable with a programmable computer, the computer program product having computer-readable code embodied therein for providing computer services, the computer-readable code comprising instructions for:
receiving a plurality of deployments of common standards-based grid services from a plurality of computer grid service providers;
registering each deployment as a computer service provider;
making the registered deployments available to customers;
receiving a request for a grid service from a customer;
matching the requested grid service with a deployment; and
linking the customer with the provider of the matched registered deployment, whereby the requested grid service is provided to the customer.

24. The computer program product of claim 23, wherein;
the request for a grid service comprises a request for a series of grid services to be performed in a predefined sequence;
matching comprises matching the requested grid services with a plurality of registered deployment; and
linking the customer comprises linking the customer with the providers of the plurality of matched registered deployments, whereby the requested grid services are provided to the customer in the predefined sequence.

25. The computer program product of claim 23, wherein the grid services comprises output workflow services.

26. The computer program product of claim 25, wherein the output workflow services are print services selected from a group comprising coverage estimation, document composition, multi-channel delivery, color conversion, indexing, pre-flighting, tamper-proofing and image delivery.

27. The computer program product of claim 23, wherein the computer-readable code further comprises instructions for charging the customer a fee to be paid to the provider of the provided grid service based on the amount of grid services provided to the customer.

28. The computer program product of claim 23, wherein the computer-readable code further comprises instructions for charging the customer a fee for being linked with the provider of the provided grid service.

29. A method for deploying computing infrastructure, comprising integrating computer readable code into a computing system wherein the code, in combination with the computing system, is capable of performing the following:
receiving a plurality of deployments of common standards-based grid services from a plurality of output workflow service provider;
registering each deployment as a service provider;
making the registered deployments available to customers;
receiving a customer request for an output workflow service;
matching the requested service with a registered service; and
linking the customer with the provider of the matched registered service, whereby the matched registered service is provided to the customer.

30. The method of claim 29, wherein:
the request for an output workflow service comprises a request for a series of output workflow services to be performed in a predefined sequence;
matching comprises matching the requested services with a plurality of registered services; and
linking the customer comprises linking the customer with the providers of the plurality of matched registered services, whereby the matched registered services are provided to the customer in the predefined sequence.

31. The method of claim 29, wherein the output workfiow services are print services selected from a group comprising coverage estimation, document composition, multi-channel delivery, color conversion, indexing, pre-flighting, tamper-proofing and image delivery.
